(19) United States
(12) Patent Application Publication
(10) Pub. No.: US 2015/0247075 A1
(43) Pub. Date: Sep. 3, 2015

(54) Two-component Polyurethane Adhesive for Gluing Fibre Mouldings

(71) Applicant: Henkel AG & Co. KGAA, Duesseldorf (DE)

(72) Inventors: Lothar Thiele, Langenfeld (DE); Dongmei Shen, Shanghai (CN); Oliver-Kei Okamoto, Duesseldorf (DE)

(21) Appl. No.: 14/711,260

(22) Filed: May 13, 2015

Related U.S. Application Data
(63) Continuation of application No. PCT/EP2013/073874, filed on Nov. 14, 2013.

(30) Foreign Application Priority Data
Nov. 14, 2012 (DE) 102012220772.4

(51) Int. Cl. C09J 175/08

(52) U.S. Cl. CPC C09J 175/08

(57) ABSTRACT

Disclosed is a 2-component polyurethane adhesive containing
a) 2 to 30% by weight of at least one oleochemical polyol having a molecular weight of greater than or equal to 500 g/mol,
b) 5 to 35% by weight of at least one 3 to 14 functional polyol,
c) 5 to 35% by weight of at least one polyol on the basis of ethoxylated or propoxylated polyphenols,
d) 0 to 20% by weight of at least one further polyol,
e) 2 to 65% by weight of at least one further additive, wherein the sum of a) to e) should be 100% by weight,
as well as an isocyanate component containing at least one aromatic and at least one aliphatic polyisocyanate in an NCO/OH ratio of 0.9:1 to 1.5:1,
wherein the cross-linked adhesive has a Tg of greater than or equal to 65° C.

Further, the use of such adhesives is described.

The invention relates to a 2-component adhesive on the basis of polyurethanes that has a high adhesive strength as well as a high glass temperature. Further, this adhesive should also have a sufficiently long processing time even at high ambient temperatures and should be able to glue even substrates with uneven surfaces and be able to bridge gaps or interspaces in a firmly adhesive manner.

Two-component polyurethane adhesives on the basis of polyols and polyisocyanates have been known for a long time. After mixing the components, two-component polyurethane adhesives can advantageously cure even at ambient temperature (“work hardening”) and can therefore rapidly take up greater forces even after a short curing time. However, for use as structural adhesives, high requirements in respect of strengths and adhesive forces are placed on such adhesives, because such adhesives are used as elements for load-bearing structures. Usually, high strengths are achieved through high cross-linking densities. This is very frequently achieved by increasing the concentration of functional groups and the use of higher functional polyols or polyamines and higher functional polyisocyanates. In the case of an excessively high crosslinking density, this may lead to embrittlement of the glue joint.

WO2002/066572 A1 describes two-component polyurethane adhesives for wood materials, which contain up to 98% of oleochemical polyols, 1 to 7.5% of a low molecular diol with an OH number between 400 and 2000, and 1 to 7.5% of a three- to five-functional polyol as well as further excipients and a resin, wherein the adhesive can be cross-linked using polyisocyanates.

DE 10 2008 060 885 A1 discloses a solvent-free 2-component adhesive for gluing sterilisable composite films, wherein the adhesive comprises a component A of at least one prepolymer containing NCO groups, produced from low molecular weight polyether alcohols, polyester alcohols and/or polyalkylene alcohols having a functionality of 2 or 3, reacted with a high molar excess of TDI, and removing the non-reacted monomer diisocyanate, as well as a component B containing at least one 2 or 3 functional polyester polyol produced from diols and/or triols on the basis of polyethers or polyalkylene diols reacted with dicarboxylic acids and the derivatives thereof, wherein at least 10 to 40% by weight of aliphatic C8 to C20 dicarboxylic acids must be present, as well as excipients and additives in at least one component A or B.

WO 2009/080740 A1 discloses a two-component polyurethane adhesive consisting of a polyol component containing 2 to 30% by weight of at least one polyester diol with a molecular weight of more than 1000 g/mol, 5 to 35% by weight of at least one 3 to 14 functional polyol, 5 to 35% by weight of hydrophobic polyols, 2 to 65% by weight of further additives or excipients, wherein the sum should be 100%, as well as a cross-linking component of polyisocyanates in an NCO/OH ratio of 0.9:1 to 1.5:1, wherein the cross-linked adhesive has a glass transition temperature (Tg) of more than 50° C.

EP2468789 A1 describes two-component polyurethane compositions, comprising castor oil, at least one alkoxylated aromatic diol, at least one polyol with 5 to 8 hydroxyl groups as well as least one polyisocyanate. It is specified that these compositions should have a long “open time” and that they should still be capable of being glued after a prolonged period of exposure to a climate with high humidity (e.g. 70% relative humidity) even after 40 minutes, in particular even after 60 minutes, and of being cured to form polymers with a high mechanical strength, so that a structural adhesive bond is produced. These two-component polyurethane compositions should in particular be suitable for use as structural adhesives, in particular for gluing wing half shells of rotor blades for wind turbines.

Such wing half shells are as a rule constructed from glass fibre reinforced plastic substrates and optionally metallic structural elements. These components must have a high mechanical stability, therefore it is desirable for the corresponding adhesive also to be able to receive corresponding forces. Apart from the above-mentioned wing half shells, there is a multiplicity of further areas of application with similar requirements to the adhesion of such components. Examples are the gluing of fibre-reinforced components for wings or other attachment parts of aeroplanes, the gluing of fibre-reinforced components in the boats industry or the above-mentioned gluing of fibre-reinforced components for producing wings for wind turbines. The mechanical requirements placed on glued components are high. They have to receive great tensile forces, the stress exerted by permanent vibrations is high and leads to material fatigue. Further, the environmental impacts are great, stability under high temperature differentials as well as constant properties at different degrees of humidity have to be ensured. It is known to glue such components alternatively with 2-component epoxy adhesives. These have sufficient strength, however they have various disadvantages in terms of processing. Thus, high curing temperatures are required in order to obtain sufficient strength. Further, the substrate surfaces have to be specially prepared for gluing. The adhesives of the prior art have the disadvantage that the glue joints do not have sufficient mechanical stability under different weather and temperature conditions. Moreover, they are less suitable for gluing large surfaces because the processing time up to the joining of the substrates is not sufficiently long, in particular in the case of elevated ambient temperatures and high humidity.

It is therefore the object of the present invention to provide an adhesive that can be used to glue plastic substrates together without prior preparation. Moreover, the adhesive should have a long open time or a long pot life and a high glass transition temperature after curing even at elevated ambient temperatures and high humidity, as will occur for example in subtropical and tropical regions. It should be possible even under such conditions to ensure a stable adhesive bond even of uneven surfaces. Moreover, foaming, bubble formation and/or too rapid skin formation should be avoided during processing at high humidity. Further, the cross-linked adhesive layers should be insensitive to humidity and different ambient temperatures and should remain stable in respect of their mechanical properties. Usually, polyurethanes with a high glass transition temperature are produced from short-chained aliphatic polyols and aromatic polyisocyanates, however, they have short pot lives or short open times.

These objects are achieved by the invention. One subject matter of the invention relates to 2-component polyurethane adhesives consisting of a polyol component containing a) 2 to 30% by weight of at least one oleochemical polyol with a molecular weight of greater than or equal to 500 g/mol, b) 5 to 35% by weight of at least one 3 to 14 functional polyol, c) 5 to 35% by weight of at least one polyol on the basis of ethoxylated or propoxylated polyphenols, d) 0 to 20% by weight of at least one further polyol, e) 2 to 65% by weight of at least one further additive, wherein the sum of a) to e) should be 100% by weight, as well as an isocyanate component containing at least one aromatic and at least one aliphatic polyisocyanate in an NCO/OH ratio of 0.9:1 to 1.5:1, wherein the cross-linked adhesive has a glass transition temperature (Tg) of greater than or equal to 65° C.

A further subject matter of the invention is the use of such 2-component polyurethane adhesives for gluing metal, plastic or foam substrates or fibre composites.

For the gluing according to the invention, known mouldings from high-strength fibre composites are suitable. These may for example consist of glass fibres, carbon fibres or aramid fibres embedded in a plastic matrix.

These fibres may be introduced into the matrix in the form of mats, fabrics, laid webs, non-wovens or rovings. This plastic matrix may for example be made from polyesters or epoxies which react to form a thermosetting polymer via suitable hardeners and/or cross-linkers. Such fibre-reinforced substrates are known to a person skilled in the art. They are used for example in aeroplane construction, in boat construction or in other components mechanically exposed to high stresses. One particular area of application for such glued substrates is their use in wings for wind turbine rotors. The methods of producing such mouldings are also known.

Such wings are for example produced in hollow mouldings and are cross-linked. In this context, the mould is frequently implemented as a half-sided mould. The side facing the mould is generally obtained in a smooth surface ready for use, the other side may, and usually should, still be processed. In doing so, two or more of these substrates are glued together during the further wing production process. In general, it is the side facing away from the mould that is glued. The surface should be designed in such a way that the substrate parts to be glued are approximately sized to fit. The surface intended for gluing may be rough and have inherent unevenness. According to the invention, no grinding or milling to an exact mirror-image form to form the counter-piece to be glued is necessary. When using the adhesive according to the invention, no pre-treatment of the surfaces to be glued is necessary either. A grease-free surface is sufficient for applying the adhesive, the use of primers is not necessary.

A known operating mode is such that after the production of the parts in the mould, the surfaces are covered on the exterior side of the mouldings with a tear resistant protective fabric for the cross-linking, which may be completely pulled off immediately prior to the later gluing and may thus result in a suitable surface. However, it is also possible to subject these surfaces to rough mechanical processing and to adapt them to the corresponding counter-piece. The adhesive according to the invention may then be applied onto the surfaces of the substrates thus prepared, which have been cleared from any loose particles.

A number of stringent requirements are placed on the gluing of the fibre composites, in particular for the wings of wind turbine rotors. Thus it should be possible to apply the adhesive at 15 to 50° C. and at 0 to 85% relative humidity (RH), however at least at 20 to 40° C. and 20 to 85% RH. It should be possible for the curing to take place at 60 to 90° C., at least 70 to 80° C. The adhesion should have a tensile shear strength of at least 12 MPa (determined according to DIN EN 1465:2009-07), a peel resistance of at least 2 MPa (determined according to DIN EN ISO 11339:2010-06), a tensile strength of >40 MPa, an elasticity modulus of greater than or equal to 4000 MPa and an elongation at break of >1% (in each case determined according to DIN EN ISO 527-2:2012-06), even after having been stored under humid conditions. The heat distortion temperature should be at least 65° C., which means that the cured adhesive has to have a glass transition temperature (Tg) of greater than or equal to 65° C. In this context, the glass transition temperature is determined using the Differential Scanning calorimetry (DSC) method according to DIN EN ISO 11357-2:1999.

The 2-component polyurethane adhesive according to the invention that meets the above-mentioned requirements is preferably pasty, however, it may also have in particular thixotropic properties. It consists of a polyol component and an isocyanate component. These two components are mixed together immediately prior to application. The polyol component must contain various multifunctional polyols. In this way, sufficient cross-linking for a mechanically stable gluing should be ensured even under thermal stress. Moreover, by selecting the different polyols it is to be ensured that sufficient hydrophobicity of the adhesive is obtained.

The prefix “poly” in substance designations such as “polyol”, “polyisocyanate”, “polyether” or “polyepoxy” as used in the present document indicates that the respective substance formally contains more than one functional group per molecule.

It is mandatory for the polyol component to contain in each case at least one compound of the group of oleochemical polyols having a molecular weight of greater than or equal to 500 g/mol (group A), the group of 3 to 14 functional polyols (group B) as well as the group of the polyols on the basis of ethoxylated or propoxylated polyphenols (group C). In terms of the application, group C does not contain any polyols that are associated with group A, and group B in turn does not contain any polyols that are to be associated with group A or group C. In addition, the polyol component may also contain polyols of group D, which only contains polyols that are not to be associated with any of groups A, B or C.

The term “oleochemical” polyols as used in the present invention is understood to refer to natural oils containing hydroxyl groups, such as castor oil, or polyols on the basis of natural oils and fats, e.g. the reaction products of epoxidised fatty substances with mono-, di- or polyfunctional alcohols or glycerine esters of long-chained fatty acids, which are at least partially substituted with hydroxyl groups.

A further group of oleochemical polyols are ring-opening and transesterification products of epoxidised fatty acid esters of lower alcohols, i.e. of epoxidised fatty acid methyl, ethyl, propyl or butyl esters. Examples to be mentioned include ring-opening and transesterification products with alcohols of functionality 2 to 4, in particular the reaction products with ethylene glycol, propylene glycol, oligomeric ethylene glycols, oligomeric propylene glycols, glycerine, trimethylolpropane or pentaerythritol. Further, derivatives of dimeric fatty acids, such as dimeric fatty acid diols, may be used. Commercially available products are for example Sovermol® 320, 650, 750, 760, 805, 810, 815, 818, 819, 860, 908, 1005, 1014, 1055, 1058, 1083, 1092, 1095, 1102, 1111 or 1140. According to the invention, the molecular weight of the oleochemical polyols to be used is greater than or equal to 500 g/mol. It is also possible to use mixtures of the above-mentioned oleochemical polyols, these preferably have a hydroxyl equivalent weight of 200 to 500 and an OH functionality of 2.3 to 4. The oleochemical polyols are contained in the polyol component of the adhesive at 2 to 30% by weight, preferably at 15 to 20% by weight.

Unless otherwise specified, the molecular weight of the substance is understood to refer to the number average molecular weight (Mₙ), determined by gel permeation chromatography (GPC) according to DIN EN ISO 16014-5:2012-10.

The OH functionality of a component is to be understood to mean the average OH functionality. It indicates the average number of hydroxyl groups per molecule. The average OH functionality of a compound may be calculated on the basis of the number average molecular weight and the hydroxyl number. Unless otherwise specified, the hydroxyl number of a compound is determined according to DIN 53240-1:2012-07. The quotient of the number average molecular weight and the OH functionality results in the hydroxyl equivalent weight of the compound. When specifying the hydroxyl equivalent weight, usually only the numerical value without the synonymously used units [g/Val], [g/eq] or [g/equ] is indicated.

The term “3 to 14 functional polyol” is to be understood to mean a compound with an average of 3 to an average of 14 hydroxyl groups per molecule. This means that this is a compound having an average OH functionality of 3 to 14.

As 3 to 14 functional polyols, preferably ethoxylation and/or propoxylation products of trimethylolpropane, glycerine, polyglycerine, pentaerythritol, erythritol, sugar alcohols or hydrogenated sugar alcohols such as xylite, dulcite, mannite or sorbite or maltitol, of carbohydrates such as sucrose, dextrose, inverted sugar, rhamnose, lactose, trehalose, maltose, cellobiose, melibiose, gentiobiose, starch decomposition products such as hydrogenated starch hydrolysates or the mixtures thereof are used. For example, ethoxylation and propoxylation products having up to 15 alkylene oxide units may be used. The production of such polyols is described for example in WO2012/134849 A1. A suitable commercial product is for example Voranol RN 490, a reaction mass of propoxylated sucrose and propoxylated glycerine. Alternatively, also the non-alkoxylated sugar alcohols may be used. The 3 to 14 functional polyols are contained in a polyol component of the adhesive at 5 to 35% by weight, preferably at 15 to 25% by weight.

Polyols on the basis of ethoxylated or propoxylated polyphenols are for example ethoxylated or propoxylated bisphenol A, bisphenol B or bisphenol F. Preferably, propoxylation products of bisphenol A having a degree of propoxylation of 2 are used, i.e. on average any phenolic group is reacted with just one molecule of propylene oxide. The ethoxylated or propoxylated polyphenols are contained in the polyol component at 5 to 20% by weight, preferably at 10 to 15% by weight.

In addition to the polyols mentioned, also further polyols may be used. In particular, polyester diols are suitable. A suitable commercial product is for example Sovermol 1006. These further polyols are contained in the polyol component at 0 to 20% by weight, preferably at 0 to 10% by weight, particularly preferably at 2 to 8% by weight.

The aromatic polyisocyanate of the isocyanate component may be isomer-pure 2,4′-diphenylmethane diisocyanate, isomer-pure 4,4′-diphenylmethane diisocyanate, a mixture of 2,4′-diphenylmethane diisocyanate and 4,4′-diphenylmethane diisocyanate, a polymeric isocyanate on the basis of 2,4′- and 4,4′-diphenylmethane diisocyanate having an NCO functionality of 2.0 to 3.2 or a mixture of the above-mentioned diphenylmethane diisocyanates. A suitable commercial product is for example Lupranat MIS. The aromatic polyisocyanate is contained in the isocyanate component of the adhesive at 40 to 70% by weight, preferably at 50 to 65% by weight.

The NCO functionality of a component is understood to mean the average number of NCO groups per molecule. The NCO functionality may be calculated from the number average molecular weight and the NCO content of the compound. The NCO content is determined according to the DIN EN ISO 11909:2007-05.

Examples of aliphatic polyisocyanates are tetramethoxybutane-1,4-diisocyanate, butane-1,4-diisocyanate, hexane-1,6-diisocyanate (HDI), 1,6-diisocyanato-2,2,4-trimethylhexane, 1,6-diisocyanato-2,4,4-trimethylhexane, 1,12-dodecane diisocyanate (C₁₂DI), isophorone diisocyanate (3-isocyanate methyl-3,5,5-trimethylcyclohexyl isocyanate, IPDI) as well as the reaction products thereof with glycerine, trimethylolpropane and the homopolymerisation and oligomerisation products thereof, in particular trimerisation products, of these in particular biuretisation products. Especially preferred is trimerised hexamethylene diisocyanate (HDI), preferably a biuretised hexamethylene diisocyanate (HDI), with an NCO functionality of 2.5 to 3.8. A suitable commercial product is for example Desmondur N 3300. The aliphatic polyisocyanate is contained in the isocyanate component of the adhesive at 20 to 45% by weight, preferably at 25 to 40% by weight.

The isocyanate component of the adhesive may also contain additives such as e.g. thixotroping agents and/or desiccants. The additives are to be selected such that they do not react with the polyisocyanates.

The two-component polyurethane adhesives according to the invention contain additives which are admixed to the polyol component and optionally to the isocyanate component. The proportion of additives in the polyol component amounts to 2 to 65% by weight. These are understood to be substances which are as a rule added in small amounts, in order to modify the properties of the adhesive in a desired direction, such as for example the viscosity, the wetting behaviour, the stability, the reaction rate, the bubble formation, the shelf life or the adhesion, but also in order to adapt the properties of use to the purpose of application. Examples of additives are fillers, flow modifiers, deaerating agents, thixotropic agents, catalysts, stabilisers, anti-ageing agents, dyes, colour pastes, pigments, desiccants, resins, plasticisers and wetting agents.

It is also possible to use catalysts, for example during the use of aliphatic isocyanates. As catalysts, the usual organometallic compounds as known in polyurethane chemistry may be used, such as e.g. iron or in particular tin compounds. Examples of these are 1,3-dicarbonyl compounds of iron, such as iron(III)-acetylacetonate, such as in particular the organotin compounds of di- and tetravalent tin, in particular the Sn(II)-carboxylates or the dialkyl-Sn(IV)-dicarboxylates or the corresponding dialkoxylates, such as e.g. dibutyl tin dilaurate, dibutyl tin diacetate, dioctyl tin diacetate, dibutyl tin maleate, tin(II)-octoate. In particular, tertiary amines or amidines may be used as catalysts, optionally in combination with the above-mentioned tin compounds. As amines, both acyclic and in particular cyclic compounds may be used here. Examples are tetramethyl butane diamine, bis(dimethyl amino ethyl)ether, 1,4-diaza-bicyclooctane (DABCO), 1,8-diaza-bicyclo-(5.4.0)-undecene, 2,2′-dimorpholino diethyl ether, dimethyl piperazine or mixtures of the above-mentioned amines. A preferred embodiment of the 2-component polyurethane adhesive according to the invention works without a catalyst.

Further, the adhesive according to the invention may optionally contain additional stabilisers. As stabilisers in terms of the present invention, antioxidants, UV stabilisers or hydrolysis stabilisers are to be understood. Examples of these are the commercially available sterically hindered phenols and/or thioethers and/or substituted benzotriazoles and/or amines of the “HALS” type (Hindered Amine Light Stabilisers).

Further, resins may optionally be included. These may be natural resins or synthetic resins. Examples are shellac, colophonium, tall oil resins, balm resins or wood rosins, hydrocarbon, terpene, cumaron/indene, furan, alkyd, glycerine ester, urea, melamine, polyamide resins, in particular also aldehyde, ketone or phenol resins. The resins generally have a low melting point and are, inter alia, advantageous for an enhanced compatibility of the components. A particular embodiment uses resins containing OH groups, in particular a plurality of OH groups. These may then also react with the isocyanates. In a preferred embodiment, the amount may be between 5 and 30% by weight.

Further, fillers may be included. As fillers in connection with isocyanates, non-reactive inorganic compounds are suitable. Examples of suitable fillers and pigments include natural, ground chalk, precipitated chalk, heavy spar, talcum, mica, carbon black, titanium dioxide, iron oxides, aluminum oxide, zinc oxide, zinc sulphate or silicon dioxide. Also water absorbent powders, for example zeolite, may be contained as a filler. The fillers should be present in a finely distributed form, for example from 1 to 200 μm, in particular up to 50 μm, however, they may also be nano-scale pigments. The amount of fillers and pigments should be 0 to 60% by weight, in particular 5 to 40% by weight. The amount of filler influences the hardness of the cross-linked adhesive. Also, the viscosity may be influenced via the amount and selection of the filler.

The additives are preferably selected such that they do not enter into a reaction or a side reaction with the isocyanates, at least not during the period of the cross-linking reaction. In particular, no additives should be added, for example carboxylic acids that promote the formation of bubbles in the adhesive. The adhesive according to the invention should further preferably not contain any organic solvents, for example those that are volatile at temperatures of up to 120° C. Plasticisers should particularly preferably not be present either.

The ratio of the isocyanate groups contained in the isocyanate component relative to the OH groups contained in the polyol components is as a rule in the range of equivalence and it is expedient if a slight excess of isocyanate groups in relation to the humidity is present at the surface. According to the invention, the NCO/OH ratio is between 0.90:1 and 1.5:1, in particular between 1.0:1 and 1.3:1.

In order to produce the 2-component polyurethane adhesive according to the invention, initially the polyol component is produced. To this end, the polyols may be mixed optionally under heating, subsequently optionally solid components should be dissolved in the mixtures. Subsequently, the additives are admixed and dispersed. In this context, the humidity content should be kept low, for example water can be reduced by means of molecular sieves. Inert additives may also partially be admixed to the isocyanate component. The two components are stored separately up to their application. For application, these two components are mixed together in a manner known per se and the mixture is applied to the substrates to be glued together.

At processing temperature, i.e. between 10 and 40° C., the adhesive according to the invention should preferably have a liquid to pasty consistency. It should be possible to apply it as a film or as a strip, without running on the substrate. The adhesive mixture according to the invention is in particular thixotropic.

Since the surfaces to be glued are frequently large surfaces and in order to allow an accurate alignment of the substrate parts to be glued, a long open time is required. According to the invention, an open time of preferably more than 60 min is achieved. The term open time is understood to be the period of time that remains after the complete mixing of the 2-component adhesive for a proper processing, before the consistency of the adhesive has changed as a result of the beginning reaction to such a degree that an application, the initial flow on the substrate and a good adhesion can no longer be achieved. In this context, the modification of the adhesive composition may be carried out by way of a purposeful cross-linking reaction, however, the pot life may also be negatively influenced by side reactions. The so-called pot life may be determined under laboratory conditions in order to estimate the open time. The pot life is the period of time between the complete mixing of the components and the onset of stringing of the adhesive mix.

Expediently, the following method is used for determining the open time: it should be possible to still homogenously compress an adhesive strip of 4 cm in height and 10 cm in width upon application of the adhesive mixture within the open time, and high strength adhesive bonds should be obtained. This strip is applied to a GRP panel 3 mm thick and is compressed after fixed periods of time (40 min, 50 min, 60 min, 70 min etc.) at 35° C. and 70% relative humidity, after a second GFP panel has been placed on top of it. The thickness of the adhesive layer should be adjusted to 3 mm using spacers. Subsequently, the adhesive is cured over 24 hours at 80° C. After the production of test specimens, the tensile shear strength is determined. The determined tensile shear strengths are compared with values derived from test specimens that are compressed immediately after the application of the adhesive. After a certain amount of time, curing has advanced to such a degree that sufficient compressibility no longer exists (identified herein below by “-”) or the tensile strength is so low that it can virtually no longer be detected with acceptable measurement accuracy (herein below identified with “-”). The open time is now the maximum amount of time, within which the strip can still be homogeneously compressed and sufficient tensile strength exists.

The following examples explain the invention, all quantities are indicated in percent by weight.

### Example 1 (Not According to the Invention)

### Polyol Component (OH Component)

| | |
|---|---|
| Castor oil | 9.0 |
| Voranol RN 490¹⁾ | 25.5 |
| Sovermol 805²⁾ | 13.5 |
| Molecular sieve³⁾ | 8.0 |
| Calcium carbonate | 41.5 |
| Fumed silica | 2.5 |

### Isocyanate Component (NCO Component)

| | |
|---|---|
| Lupranat MIS⁴⁾ | 88.5 |
| Molecular sieve | 5.5 |
| Fumed silica | 6.0 |

1) Polyether polyol on sugar basis, Dow Company, hydroxyl equivalent weight 114
2) Branched polyether/ester, BASF, hydroxyl equivalent weight 330
3) Zeolite type
4) 2,4′-,4,4′-diphenylmethane diisocyanate, isomer mix (50:50), BASF Company
Mixing ratio as a ratio of parts by weight (OH component:NCO component): 100:48

| Pot life (at room temperature) | 110 min | | | | |
|---|---|---|---|---|---|
| Glass transition temperature (DSC) | 83° C. | | | | |
| Tensile strength | 43.0 MPa | | | | |
| t/min | 0 | 40 | 50 | 60 | 70 |
| Compressibility | + | + | − | − | − |
| Tensile shear strength/MPa | 14.0 | 11.3 | − | − | − |

### Example 2 (Not According to the Invention)

### Polyol Component (OH Component)

| | |
|---|---|
| Castor oil | 9.0 |
| Voranol RN 490 | 25.5 |
| Sovermol 805 | 13.5 |
| Molecular sieve | 8.0 |
| Calcium carbonate | 41.5 |
| Fumed silica | 2.5 |

### Isocyanate Component (NCO Component)

| | |
|---|---|
| Lupranat MIS | 48.5 |
| Desmodur N 3300⁵⁾ | 40.0 |
| Molecular sieve | 5.5 |
| Fumed silica | 6.0 |

5) Trimerised hexamethylene diisocyanate, Bayer MaterialScience Company
Mixing ratio as a ratio of parts by weight (OH component:NCO component): 100:58

| Pot life (at room temperature) | 225 min | | | | |
|---|---|---|---|---|---|
| Glass transition temperature (DSC) | 53° C. | | | | |
| Tensile strength | 38.2 MPa | | | | |
| t/min | 0 | 40 | 50 | 60 | 70 |
| Compressibility | + | + | + | + | + |
| Tensile shear strength/MPa | 11.2 | 11.0 | 10.0 | 10.1 | 8.7 |

### Example 3 (According to the Invention)

### Polyol Component (OH Component)

| | |
|---|---|
| Castor oil | 5.0 |
| Voranol RN 490 | 25.5 |
| Sovermol 819⁶⁾ | 10.0 |
| Dianol 320⁷⁾ | 10.5 |
| Molecular sieve | 8.0 |
| Calcium carbonate | 41.5 |
| Fumed silica | 2.5 |

### Isocyanate Component (NCO Component)

| | |
|---|---|
| Lupranat MIS | 58.5 |
| Desmodur N 3300 | 30.0 |
| Molecular sieve | 5.5 |
| Fumed silica | 6.0 |

6) Fatty acid ester, BASF Company, hydroxyl equivalent weight 234
7) Propoxylated bisphenol A, Arkema Company, hydroxyl equivalent weight 174
Mixing ratio as a ratio of parts by weight (OH component:NCO component): 100:60

| Pot life (at room temperature) | 180 min | | | | |
|---|---|---|---|---|---|
| Glass transition temperature (DSC) | 73° C. | | | | |
| Tensile strength | 54.0 MPa | | | | |
| t/min | 0 | 40 | 50 | 60 | 70 |
| Compressibility | + | + | + | + | (+) |
| Tensile shear strength/MPa | 15.1 | 15.0 | 14.0 | 12.8 | 9.0 |

### Example 4 (According to the Invention)

### Polyol Component (OH Component)

| | |
|---|---|
| Sovermol 1006⁸⁾ | 6.0 |
| Voranol RN 490 | 20.5 |
| Sovermol 819 | 10.0 |
| Dianol 320 | 11.5 |
| Molecular sieve | 8.0 |
| Calcium carbonate | 41.5 |
| Fumed silica | 2.5 |

### Isocyanate Component (NCO Component)

| | |
|---|---|
| Lupranat MIS | 55.5 |
| Desmodur N 3300 | 35.0 |
| Molecular sieve | 5.5 |
| Fumed silica | 6.0 |

8) Polyester diol, BASF, hydroxyl equivalent weight 935
Mixing ratio as a ratio of parts by weight (OH component:NCO component): 100:56

| Pot life (at room temperature) | 210 min | | | | |
|---|---|---|---|---|---|
| Glass transition temperature | 69° C. | | | | |
| (DSC) | | | | | |
| Tensile strength | 51.0 MPa | | | | |
| t/min | 0 | 40 | 50 | 60 | 70 |
| Compressibility | + | + | + | + | − |
| Tensile shear strength/MPa | 14.6 | 14.1 | 14.1 | 12.2 | − |

The short pot life and the open time of example 1 not according to the invention can be extended by means of an isocyanate component with an aliphatic isocyanate in example 2. However, this leads to a reduction of the glass transition temperature and the tensile strength below the claimed values. It is not until the aromatic polyol has been introduced that products with long pot lives and open times, high glass temperatures and tensile strengths are obtained in examples 3 and 4 according to the invention.

What is claimed is:

1. Two-component polyurethane adhesive consisting of a polyol component containing
a) 2 to 30% by weight of at least one oleochemical polyol having a molecular weight greater than or equal to 500 g/mol,
b) 5 to 35% by weight of at least one 3 to 14 functional polyol,
c) 5 to 35% by weight of at least one polyol on the basis of ethoxylated or propoxylated polyphenols,
d) 0 to 20% by weight of at least one further polyol,
e) 2 to 65% by weight of at least one further additive, wherein the sum of a) to e) should be 100% by weight,
as well as an isocyanate component containing at least one aromatic and at least one aliphatic polyisocyanate in an NCO/OH ratio of 0.9:1 to 1.5:1,
wherein the cross-linked adhesive has a Tg of greater than or equal to 65° C.

2. Two-component polyurethane adhesive according to claim 1, characterised in that the at least one further polyol d) is a polyester diol.

3. Two-component polyurethane adhesive according to claim 1, characterised in that the cross-linked adhesive has an elasticity modulus of greater than or equal to 4000 MPa and a tensile strength of greater than or equal to 40 MPa.

4. Two-component polyurethane adhesive according to claim 1, characterised in that the oleochemical polyol(s) a) has/have a hydroxyl equivalent weight of 150 to 500 and an OH functionality of 2.3 to 4.

5. Two-component polyurethane adhesive according to claim 1, characterised in that the 3 to 14 functional polyol(s) b) are ethoxylated and/or propoxylated carbohydrates.

6. Two-component polyurethane adhesive according to claim 1, characterised in that the ethoxylated or propoxylated polyphenol(s) c) is/are propoxylated bisphenol A, bisphenol B or bisphenol F, preferably with a degree of propoxylation of 2.

7. Two-component polyurethane adhesive according to claim 1, characterised in that the aromatic polyisocyanate is isomer-pure 2,4′-diphenylmethane diisocyanate, isomer-pure 4,4′-di-phenylmethane diisocyanate, a mixture of 2,4′-diphenylmethane diisocyanate and 4,4′-diphenyl-methane diisocyanate, a polymeric isocyanate on the basis of 2,4′- and 4,4′-diphenylmethane diisocyanate with an NCO functionality of 2.0 to 3.2 or a mixture of the above-mentioned diphenylmethane diisocyanates.

8. Two-component polyurethane adhesive according to claim 1, characterised in that the aliphatic polyisocyanate is a trimerised hexamethylene diisocyanate or a biuretised hexamethylene diisocyanate with an NCO functionality of 2.5 to 3.8.

9. Use of a two-component polyurethane adhesive according to claim 1 for gluing metal, plastic or foam substrates or fibre composites.

10. Use according to claim 9 for gluing mouldings on the basis of glass fibres, carbon fibres, textile fibres in a polyester or polyepoxy matrix.

11. Use according to claim 9 for gluing mouldings with an uneven surface.
